(19) United States
(12) Patent Application Publication
(10) Pub. No.: US 2006/0208065 A1
(43) Pub. Date: Sep. 21, 2006

(54) Method for managing consumer accounts and transactions

(76) Inventors: Isaac Mendelovich, Elkins Park, PA (US); Zvi Meshi, Tel-Aviv (IL); Jack M. Kaplan, Princeton, NJ (US); David Carrithers, Reston, VA (US); David Berk, East Brunswick, NJ (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(21) Appl. No.: 11/334,766

(22) Filed: Jan. 18, 2006

Related U.S. Application Data
(60) Provisional application No. 60/714,482, filed on Sep. 6, 2005.
(60) Provisional application No. 60/712,323, filed on Aug. 29, 2005.
(60) Provisional application No. 60/707,887, filed on Aug. 12, 2005.
(60) Provisional application No. 60/644,724, filed on Jan. 18, 2005.

(51) Int. Cl. G06K 5/00; G07G 1/14; G06Q 40/00

(52) U.S. Cl. 235/380; 705/14; 705/39

(57) ABSTRACT

A method and system includes at least one transaction network configured to route credit card or ACH/debit card transactions. A compilation credit card is associated with the existing credit card accounts of the consumer. A compilation card service provider has a compilation card database that stores information about the plurality of existing credit card accounts belonging to the consumer and a consumer preferences database that stores predefined preferences of the consumer. The compilation card service provider is accessible by the at least one transaction network to receive credit card transaction requests or ACH/debit card transaction requests based on the compilation credit card number. One of the compilation credit card and the compilation card service provider is configured to select one of an existing credit card account among the plurality of existing credit card accounts to which to charge a particular transaction based on the predefined preferences of the consumer.

### CROSS-REFERENCE TO RELATED APPLICATIONS

This application claims priority to U.S. Provisional Patent Application No. 60/714,482 filed on Sep. 6, 2005, entitled “Method for Managing Consumer Accounts and Transactions;” U.S. Provisional Patent Application No. 60/712,323 filed on Aug. 29, 2005, entitled “Method for Managing Consumer Accounts and Transactions;” U.S. Provisional Patent Application No. 60/707,887 filed on Aug. 12, 2005, entitled “Method for Managing Consumer Accounts and Transactions;” and U.S. Provisional Patent Application No. 60/644,724 filed on Jan. 18, 2005, entitled “Method for Compiling, Exchanging and Redeeming Award Points” the entire contents of all of which is incorporated by reference herein.

### BACKGROUND OF THE INVENTION

1. Field of Invention

The present invention relates to a method for managing financial cards and consumer accounts and transactions by aggregating a plurality of consumer accounts and providing a consumer accessible portal for defining preferences.

2. Description of Prior Art

The generic term financial cards include credit cards, debit cards, gift cards, ATM cards, and other financial data. Financial data cards are now ubiquitous, their use has proliferated to such an extent that users of the cards find it objectionable and burdensome to carry all that seem required if one is to function in today's society. In addition, loyalty/rewards and reward programs are well known. Airline frequent flyer programs are one of the most well known rewards programs. In 1981, American Airlines® introduced AAdvantage which was the first frequent flyer program in the world. Frequent flyer programs were created to provide an incentive for consumers to fly a particular airline. Each airline has a proprietary database for tracking frequent flyer miles (i.e., airline award points) for a particular consumer. Consumers are awarded frequent flyer miles for the length of a flight, the number of “legs” in a particular trip and the frequency of flying. As a consumer accumulates a large number of frequent flyer miles (e.g., 25,000 to 50,000 miles), the consumer may be elevated to an elite status such as gold or preferred. Frequent flyer miles can be used to upgrade travel on a particular flight, to obtain free air travel on the particular airline or free travel and stays with affiliated airlines and/or subsidiaries.

Other industries also have gift card and loyalty/rewards cards and frequent travel programs. For example, hotels, rental car companies, retailers, credit card companies and the like all have proprietary award programs and often-proprietary gift cards. The rewards can be referred to as rewards, bonuses, credits, loyalty incentives, currencies, miles or the like.

Since each of the proprietary award programs requires a separate proprietary award account, a consumer ends up with a plurality of proprietary loyalty/rewards or loyalty/rewards cards. If the consumer forgets to bring a particular loyalty/rewards card on a trip, the consumer may not be able to get award points for travel or purchases. Additionally, it is inconvenient and cumbersome to carry three, five, seven or more separate loyalty/rewards cards. Credit card experts suggest the consumer should carry only those credit cards that they plan to use and leave the other ones at home. This requires the consumer to decide which cards to take when leaving the house.

FIG. 10 shows a conventional credit transaction system 100. When a consumer desires to carry out a credit card transaction in order to purchase a product or service provided by a vendor, a vendor transaction system 105 is used to transmit credit card account transaction information over a network 110 to one of a plurality of credit card companies such as a gift card 167, MasterCard® 115, Visa® 120, Discover® 125 and American Express® 130, that process the transaction and authorize or decline the transaction. The vendor uses a card reader or point of sale terminal (POS) 135 to read information from a magnetic stripe (mag-stripe) on the surface of the credit card 140 presented by the consumer. Transactions can also be performed over the internet 150 by manually entering the particular respective card account number and consumer information. If the consumer has more than one card 140, the consumer must decide which card 140 should be used. Many cards 140 offer incentives, such as air travel miles, cash back, awards points and the like, so the consumer may find it difficult to remember which card 140 provides a particular incentive and the consumer may not be aware of special promotions offered by a particular card 140 at a certain time of year.

It is desirable to provide a method for compiling, exchanging and redeeming award points/miles/currencies/credits. It is also desirable for a consumer to be able to register and access one of a plurality of consumer financial award accounts and/or financial credit or debit card accounts and/or gift card accounts and/or promotional accounts through the use of a single card (hereinafter referred to as a “compilation account”). Furthermore, it would be desirable to provide a method and system for compiling, exchanging and redeeming award points/miles/currencies/credits utilizing such a compilation card to perform transactions. Furthermore, it would be desirable to automatically determine the best credit card or loyalty/rewards account to use for each transaction based on the consumer's preferences/criteria by establishing a personal profile that is referenced each time the compilation account is used. It is also desirable to provide the consumer with a system for managing consumer accounts and transactions.

It would also be desirable to give the consumer the opportunity to use one card to earn extra income by providing a user-friendly forum for the consumer to receive a share of revenue generated by a service provider that manages the consumer's credit card and/or loyalty/rewards card transactions and offers merchants access to the consumer's personal transaction information. It is also desirable to give the consumer the power to demand specific levels of compensation for providing such personal information. It would also be desirable to expand the opportunity for merchants to attract new customers by providing a portal that draws consumers and provides a medium for merchants to entice the consumers with offers. It would also be desirable to allow the consumer to share a portion of all of their rewards and/or loyalty/incentive revenue with selected charities of their choice.

### BRIEF SUMMARY OF THE INVENTION

Briefly stated, embodiments of the present invention comprise a method and system that permits a consumer to access one of a plurality of existing loyalty/rewards accounts belonging to the consumer. The system includes at least one transaction network configured to route loyalty/rewards transactions and a compilation account that is associated with the plurality of existing loyalty/rewards accounts of the consumer. The compilation account has a compilation account number associated therewith. A compilation account service provider has a compilation account database that stores information about the plurality of existing loyalty/rewards accounts belonging to the consumer and a consumer preferences database that stores preferences of the consumer. The compilation account service provider has access to the plurality of existing loyalty/rewards accounts. The compilation account service provider is accessible by the at least one transaction network to receive loyalty/rewards account transaction requests based on the compilation account number. One of the compilation account and the compilation account service provider is configured to select one of the existing loyalty/rewards accounts among the plurality of existing loyalty/rewards accounts to which to apply a particular loyalty/rewards transaction based on the predefined preferences of the consumer.

Another embodiment of the present invention comprises a method of using one of a plurality of existing loyalty/rewards accounts belonging to a consumer. Account data is provided to a compilation account service provider for a plurality of existing loyalty/rewards accounts belonging to the consumer. Preferences of the consumer that determine selection of one of the plurality of existing/rewards accounts are stored. The consumer is provided with a compilation account associated with the plurality of existing loyalty/rewards accounts of the consumer. The consumer performs a loyalty/rewards transaction using the compilation account. The loyalty/rewards transaction qualifies for award points using one of the plurality of existing loyalty/rewards accounts. One of the plurality of existing loyalty/rewards accounts is selected to use in completing the loyalty/rewards transaction based on the stored preferences of the consumer.

Another embodiment of the present invention comprises a system that permits a consumer to access one of a plurality of existing credit card accounts and a plurality of existing loyalty/rewards accounts belonging to a consumer. The system includes at least one credit card transaction network configured to route credit card transactions and a compilation account that is associated with the plurality of existing credit card accounts and the plurality of existing loyalty/rewards accounts of the consumer. The compilation account has a compilation account number associated therewith. A compilation account service provider has a compilation account database that stores information about the plurality of existing credit card accounts and the plurality of existing loyalty/rewards accounts belonging to the consumer and a consumer preferences database that stores preferences of the consumer. The compilation account service provider has access to the plurality of existing credit card accounts and the plurality of existing loyalty/rewards accounts of the consumer. The compilation account service provider is accessible by the at least one credit card transaction network to receive credit card and loyalty/rewards account transaction requests based on the compilation account number. One of the compilation account and the compilation account service provider is configured to select one of an existing credit card account and an existing loyalty card account among the respective plurality of existing credit card accounts and the respective plurality of existing loyalty card accounts to which to charge a particular credit card transaction or credit a particular loyalty/rewards account transaction based on the predefined preferences of the consumer.

Another embodiment of the present invention comprises a method and system that permits a consumer to access one of a plurality of existing credit card accounts belonging to the consumer. The system includes at least one transaction network configured to route credit card or ACH/debit card transactions. A compilation credit card is associated with the plurality of existing credit card accounts of the consumer. The compilation credit card has a compilation credit card number associated therewith. A compilation card service provider has a compilation card database that stores information about the plurality of existing credit card accounts belonging to the consumer and a consumer preferences database that stores predefined preferences of the consumer. The compilation card service provider has access to the plurality of existing credit card accounts. The compilation card service provider is accessible by the at least one transaction network to receive credit card transaction requests or ACH/debit card transaction requests based on the compilation credit card number. One of the compilation credit card and the compilation card service provider is configured to select one of an existing credit card account among the plurality of existing credit card accounts to which to charge a particular transaction based on the predefined preferences of the consumer.

Another embodiment of the present invention comprises a method of using one of a plurality of existing credit accounts belonging to a consumer. Account data is provided to a compilation account service provider about the plurality of existing credit accounts belonging to the consumer. The consumer is provided with a compilation account associated with the plurality of existing credit accounts of the consumer. Preferences of the consumer that determine selection of one of the plurality of existing credit accounts belonging to the consumer are stored. The consumer performs a primary credit transaction using the compilation account. A secondary credit transaction related to the primary transaction is performed between the compilation account and one of the plurality of existing credit accounts based on the stored preferences of the consumer.

Another embodiment of the present invention comprises a method of performing a debit/PIN transaction using one of a plurality of existing credit accounts belonging to a consumer. Account data is provided to a compilation account service provider about the plurality of existing credit accounts belonging to the consumer. The consumer is provided with a compilation account associated with the plurality of existing credit accounts of the consumer. Preferences of the consumer that determine selection of one of the plurality of existing credit accounts belonging to the consumer are stored. The consumer performs a debit/PIN transaction using the compilation account. At the compilation account service provider, the debit/PIN transaction is treated as a credit transaction directed to one of the plurality of existing credit accounts based on the stored preferences of the consumer.

Another embodiment of the present invention comprises a method of performing a debit/PIN transaction using one of an existing credit account and an existing checking/savings account belonging to a consumer. Account data is provided to a compilation account service provider about the existing credit account and the existing checking/savings account belonging to the consumer. The consumer is provided with a compilation account associated with the existing credit account and the existing checking/savings account of the consumer, the compilation account having a personal identification number (PIN) associated therewith. Preferences of the consumer that determine selection of one of the existing credit account and the existing checking/savings account of the consumer are stored. The consumer performs a debit/PIN transaction using the compilation account by entering the PIN. At the compilation account service provider, the debit/PIN transaction is treated as one of (i) a credit transaction directed to the existing credit account and (ii) a debit transaction directed to the existing checking/savings account based on the stored preferences of the consumer.

Another embodiment of the present invention comprises a method of performing a debit/PIN transaction using one of a plurality of existing credit accounts and an existing checking/savings account belonging to a consumer. Account data is provided to a compilation account service provider about the plurality of existing credit accounts and the existing checking/savings account belonging to the consumer The consumer is provided with a compilation account associated with the plurality of existing credit accounts and the existing checking/savings account of the consumer. The compilation card has a first personal identification number (PIN) and a second PIN associated therewith. The consumer performs a debit/PIN transaction using the compilation account by entering one of the first PIN and the second PIN. At the compilation account service provider, the debit/PIN transaction is treated as one of (i) a debit transaction directed to the existing checking/savings account when the first PIN is entered by the consumer and (ii) a credit transaction directed to one of the plurality of existing credit accounts when the second PIN is entered by the consumer. The credit transaction is directed to one of the plurality of existing credit accounts based on the stored preferences of the consumer.

Another embodiment of the present invention comprises a method of managing a plurality of existing credit accounts belonging to a consumer. The consumer is provided with a compilation account associated with the plurality of existing credit accounts of the consumer. A user accessible internet-based portal for managing the compilation account is provided. Account data is inputted by the consumer, through the internet-based portal, to a compilation account service provider about the plurality of existing credit accounts belonging to the consumer. Preferences are set by the consumer, through the internet-based portal, that determine which of the plurality of existing credit accounts to use for a particular type of transaction. The consumer performs one of a credit transaction and a debit/PIN transaction using the compilation account. At the compilation account service provider, the respective one of the credit transaction and the debit/PIN transaction is treated as a credit transaction directed to a particular one of the plurality of existing credit accounts based on the preferences at least partially set by the consumer.

Another embodiment of the present invention comprises a computer-implemented method of using an electronic message sent to a wireless communications device of a consumer to offer promotions. Account data is provided to a compilation account service provider about a plurality of existing credit/loyalty accounts belonging to the consumer. The consumer is provided with a compilation account associated with the plurality of existing credit/loyalty accounts of the consumer. Preferences of the consumer that determine selection of one of the plurality of existing credit/loyalty accounts belonging to the consumer are stored. An electronic message is sent to the wireless communications device of the consumer. The electronic message offers the consumer one of a specific special, a program offering, and a merchant or manufacture promotional offering that is targeted to the consumer. The consumer accepts the offer the offer by responding to the electronic message, and based on the response at least temporarily resets, overrides or changes the consumer preferences based on the offering.

Another embodiment of the present invention comprises a computer-implemented method of using a database to store information and preferences on charitable organizations. Account data is provided to a compilation account service provider about a plurality of existing credit/loyalty accounts belonging to the consumer. The consumer is provided with a compilation account associated with the plurality of existing credit/loyalty accounts of the consumer. Preferences of the consumer that determine selection of one of the plurality of existing credit/loyalty accounts belonging to the consumer are stored. Based on the consumer preferences, earnings and contributions are selectively given to the chartable organizations based on specials and/or promotional offerings based on purchasing activities, discounts or seasonal activities.

Another embodiment of the present invention comprises a computer-implemented method of using a database tracking transactions on a variety of payment types and processes. Account data is provided to a compilation account service provider about a plurality of existing credit/loyalty accounts belonging to the consumer. The consumer is provided with a compilation account associated with the plurality of existing credit/loyalty accounts of the consumer. Preferences of the consumer that determine selection of one of the plurality of existing credit/loyalty accounts belonging to the consumer are stored. Interchange fees, transaction fees and general charitable donations are shared based on at least one of transaction volume, transaction activities, transaction source, and transaction type.

### BRIEF DESCRIPTION OF THE SEVERAL VIEWS OF THE DRAWINGS

The following detailed description of the preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a block diagram of a system for compiling, exchanging and redeeming award points/miles/currencies/credits from a plurality of proprietary award accounts in accordance with a first preferred embodiment of the present invention;

FIG. 2 is an exemplary statement from a customer selected financial institution for use with the preferred embodiments;

FIG. 3 is a block diagram of a rewards-currency consortium and system in accordance with the preferred embodiments of the present invention;

FIG. 4 is an exemplary consumer rewards-currency card profile or record in accordance with the preferred embodiments of the present invention;

FIG. 4 is an exemplary time/value diagram demonstrating the value of rewards-currency in accordance with the preferred embodiments of the present invention;

FIG. 6 is an exemplary advertisement for utilizing rewards-currency in accordance with the present invention;

FIG. 7 is a diagram of an apparatus used to implement compilation card transactions in accordance with a second preferred embodiment of the present invention;

FIG. 8 is an exemplary top plan view of a compilation card in accordance with the preferred embodiments of the present invention;

FIG. 9 is a consumer credit card correlation database in accordance with the second preferred embodiment of the present invention;

FIG. 10 is a block diagram of a conventional prior art credit card transaction management system;

FIG. 11 is a block diagram of a system for managing consumer accounts and transactions by aggregating a plurality of consumer accounts in accordance with a third preferred embodiment of the present invention; and

FIG. 12 is a screen shot of a consumer accessible portal for defining consumer account management preferences in accordance with a fourth preferred embodiment of the present invention.

### DETAILED DESCRIPTION OF THE INVENTION

Certain terminology is used in the following description for convenience only and is not limiting. “Compilation” refers to combining, gathering and/or aggregating a plurality of different sources and/or a collection of sources. “Credit card” includes any one or more of a credit card, a charge card, a check card, a debit card, a stored value card, a phone card, a gift card, an automated teller machine (ATM) card, and the like. “Loyalty/rewards card” includes any one or more of a loyalty/rewards card, an award(s) card, a rewards card, a frequent flyer membership, a club membership and the like. Additionally, the word “a” as used in the claims and in the corresponding portions of the specification, means “at least one.”

As used herein, “award points” refers broadly to any reward, bonus, credit or loyalty incentive including reward, loyalty, award, bonus, incentive, travel points or credits or currencies or miles, and also may refer to travel miles, hotel miles, hotel points, reward nights, reward stays, rental car miles, bonus rentals, rental car points, promotional currencies, award currencies, loyalty currencies or the like, and should not be construed as limiting.

To implement the present invention, a system and method is implemented for compiling awards points from a plurality of loyalty/rewards accounts into a proprietary universal currency having its own denomination “ [symbol] ” referred to hereinafter as “rewards-currency [symbol] .” The valuation system for this new rewards-currency [symbol] is similar to that of monetary systems such as the U.S. dollar ($), the British pound (£), the Euro ( [symbol] ), the Yen (¥) and the like, although the new rewards-currency [symbol] is not issued by a sovereign nation, but by a consortium of financial institutions and/or business entities.

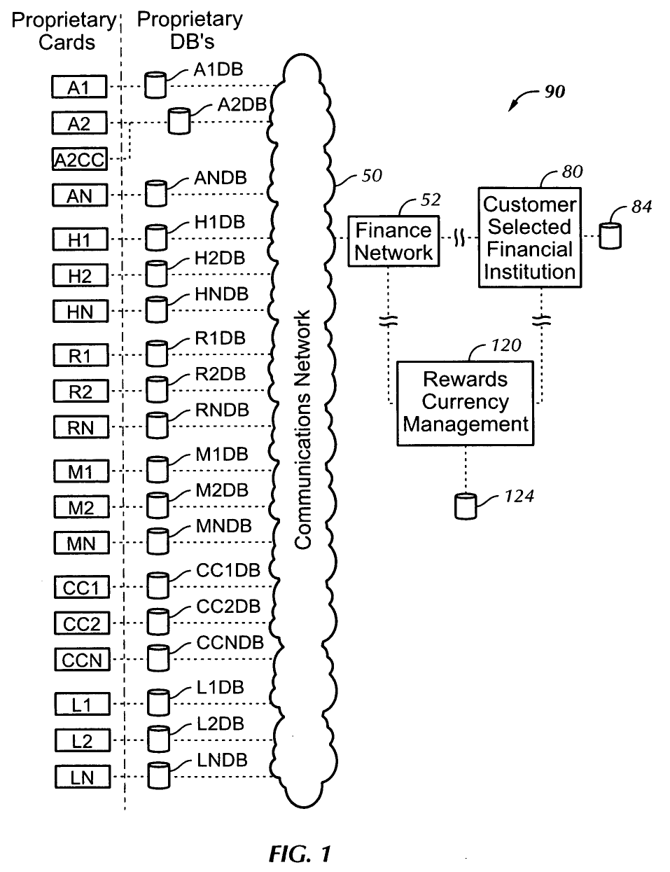

FIG. 1 shows a system 90 for compiling, exchanging and redeeming award points/miles/currencies/credits in accordance with the first preferred embodiment of the present invention. As shown, a plurality of proprietary cards A1, A2, A2CC, AN, H1, H2, HN, R1, R2, RN, M1, M2, MN, CC1, CC2, CCN, L1, L2, LN (“A1-LN”), each having a respective account number, collect award or loyalty/rewards data which is stored in a plurality of proprietary databases A1DB, A2DB, ANDB, H1DB, H2DB, HNDB, R1DB, R2DB, RNDB, M1DB, M2DB, MNDB, CC1DB, CC2DB, CCNDB, L1 DB, L2DB, LNDb, respectively, anD associate the loyalty/rewards data with the respective account numbers of the proprietary cards A1-LN. Data from the proprietary databases is sent through an existing communications network 50 to a finance or financial network 52. The financial network 52 may be similar to the American Bankers' Association (ABA) network or may be like a proprietary dedicated network utilized by large chain stores and retailers. The finance network 52 is coupled to a customer selected financial institution 80 and a rewards-currency management organization 120. The customer selected financial institution 80 is preferably a bank that issues accounts like credit cards and debit cards. The customer selected financial institution or bank 80 has a database 84 for tracking detailed financial information and/or rewards-currency information for a particular consumer. The rewards-currency management organization 120 has a separate database 124 that stores information about the consumer's transactions.

The proprietary cards A1-LN are issued by airlines A1-AN, hotels H1-HN, rental car companies R1-RN, merchants M1-MN, credit card companies CC1-CCN, and loyalty/rewards programs L1-LN and the like. A consumer may individually have a plurality of each type of card A1-LN. In other words, a consumer may have a proprietary card A1-LN from a first airline A1, and a proprietary card from a second airline A2 as well as a credit card A2CC that provides award points for the second airline as well. The awards points may be in the form of frequent flyer miles, hotel stay points, rental car award points and the like.

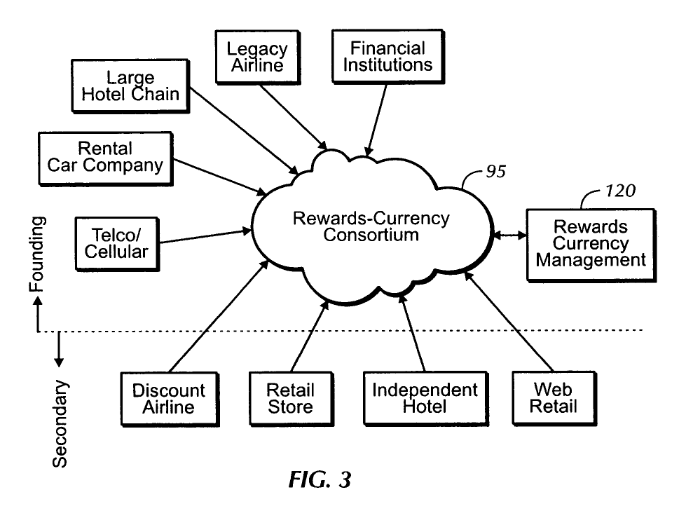

FIG. 3 shows a rewards-currency consortium 95. The rewards-currency consortium 95 is a partnering of legacy airlines, large hotel chains, rental car companies, telephone and/or cellular telephone companies with financial institutions and a rewards-currency management organization 120. The members of the rewards-currency consortium 95, by agreement, set transfer and conversion rates of their respective awards points for transactions to a consumer account at one of the customer selected financial institutions 80. The members of the rewards-currency consortium 95 work together to promote the universal rewards-currency [symbol] . The member financial institutions in the rewards-currency consortium 95 insure, issue and market the rewards-currency [symbol] similar to money. The rewards-currency management organization 120 promotes and markets the rewards-currency [symbol] , tracks consumer transactions, markets and sells consumer transactions, and recruits secondary members to the rewards-currency consortium 95. Secondary members of the rewards-currency consortium 95 such as discount airlines, retail stores, independent hotels, web retailers and the like provide additional sources for consumers to collect awards points for conversion to rewards-currency [symbol] and avenues to exchange and redeem awards points using rewards-currency [symbol] . The rewards-currency consortium 95 will take award points from all types of loyalty/rewards programs that flow into a consumer's proprietary accounts and compile them into a single rewards-currency account.

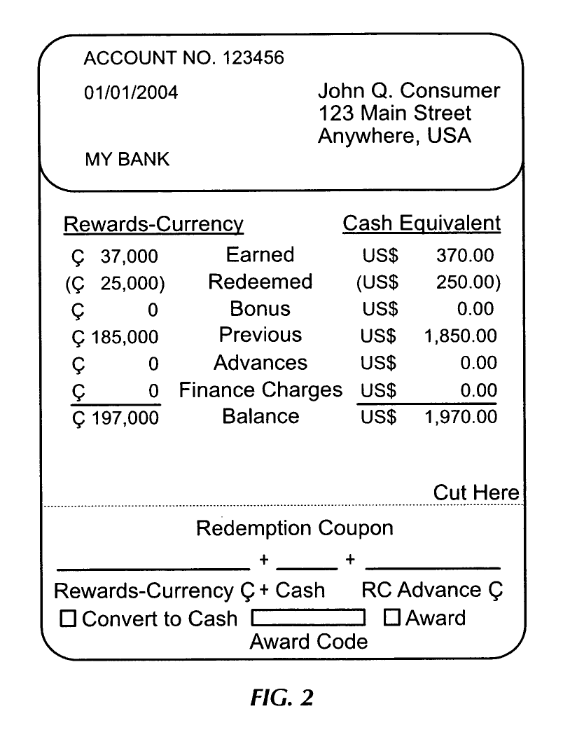

FIG. 2 is an exemplary consumer statement for a rewards-currency account (e.g., account number 123456). The statement shows a summary of rewards-currency earned, redeemed, bonuses, previous account balance, rewards-currency advances, finance charges and a current balance. The statement also shows a cash equivalent of the rewards-currency [symbol] . A primary benefit to converting awards points to rewards-currency [symbol] is that rewards-currency [symbol] has a base value or cash equivalent such as $0.01 (see FIG. 5). Therefore, consumers will be more confident in using awards programs because the consumer knows they can redeem rewards-currency [symbol] as cash even if a particular airline, hotel chain or rental car company goes bankrupt. The exemplary statement is shown with a redemption coupon for redeeming rewards-currency [symbol] to be converted to cash or as an award code with a combination of rewards-currency [symbol] and cash or with a rewards-currency advance.

A rewards-currency advance is similar to a cash advance on a credit card so that if a consumer desires to obtain an award such as an airline ticket, but the consumer does not have a current balance sufficient to redeem such an award, the consumer can take a rewards-currency advance for the difference or make up the difference with cash. The customer selected financial institution 80 then charges the consumer a finance charge based on the rewards-currency advance, similar to a cash advance on a regular credit card. In effect, the customer selected financial institution 80 will make a loan and charge interest for a rewards-currency advance.

Thus, the system 90 includes a plurality of loyalty/rewards accounts A1-LN belonging to a consumer that each issue awards points; at least one communications network 52 configured to route loyalty/rewards transactions; a compilation account 123456 (FIG. 2) belonging to the consumer and associated with the plurality of loyalty/rewards accounts A1-LN; and a customer selected financial institution 80 having a loyalty/rewards account database 84 that stores information about the plurality of existing loyalty/rewards accounts A1-LN belonging to the consumer and a consumer preferences database 124 that stores preferences of the consumer. The customer selected financial institution 80 has access to the plurality of existing loyalty/rewards accounts A1-LN of the consumer. The customer selected financial institution 80 is accessible by the at least one communications network 52 to receive loyalty/rewards account transaction requests using the compilation account. The customer selected financial institution 80 converts the awards points from the plurality of loyalty/rewards accounts A1-LN to rewards-currency [symbol] that is stored in the compilation account 123456 (FIG. 2) of the consumer. Furthermore, the preferred embodiments of the present invention include using the universal rewards currency [symbol] having its own denomination and valuation system that is universal between a plurality of rewards/awards programs.

The founding members of the rewards-currency consortium 95 preferably have high fixed costs (i.e., significant infrastructure), but low variable costs, so that it will be profitable for them to be members of the rewards-currency consortium 95. For example, an airline has a large amount invested in airplanes and terminal leases, but the cost of filling an empty seat is comparatively negligible. While there may be some loss in loyalty due to consumers redeeming points garnered from one loyalty/rewards program to another, there is a competing theory that consumers currently have lost confidence in the long-term viability of many awards programs and without such redemption options are not going to be loyal to a particular loyalty/rewards program anyway. Accordingly, it is in the collective interests of the loyalty/rewards programs to support such a system 90.

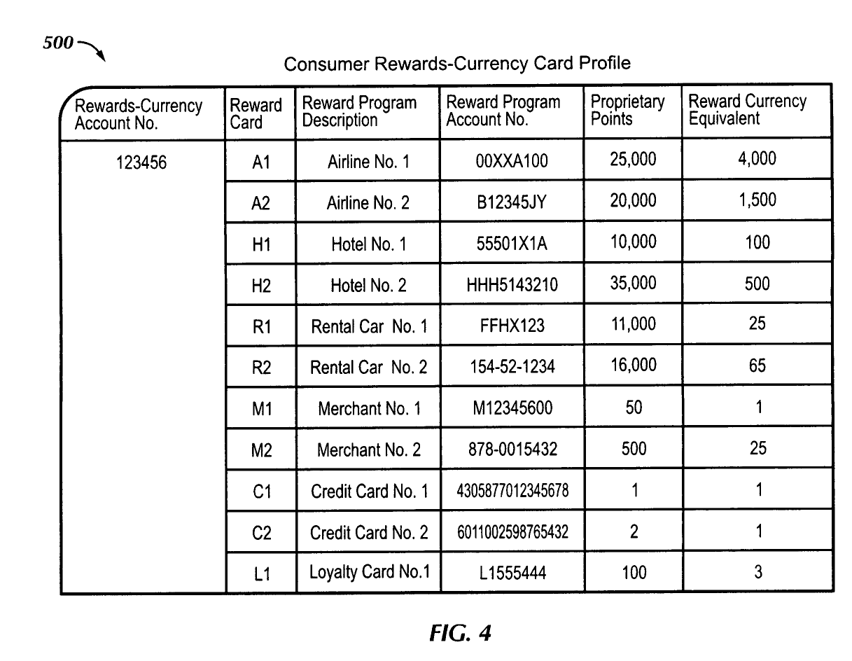

FIG. 4 shows a consumer rewards-currency card profile 500 for a particular rewards-currency account, in this case rewards-currency account number 123456. A subset A1-A2, H1-H2, R1-R2, M1-M2, C1-C2, L1 of proprietary cards or loyalty/reward cards A1-LN (see the proprietary cards of FIG. 1) are linked to the rewards-currency account number 123456 for this particular consumer. A loyalty/rewards card A1 corresponds to airline number 1 having a reward program account number of 00XXA100. A loyalty/rewards card A2 for airline number 2 has a reward program account number B12345JY. A loyalty/rewards card H1 for hotel number 1 has a reward program account number 55501X1a. A loyalty/rewards card H2 for hotel number 2 has a reward program account number HHH5143210. A loyalty/rewards card R1 for rental car number 1 has a reward program account number FFHX123. A loyalty/rewards card R2 for rental car number 2 has a reward program account number 154-S2-1234. A loyalty/rewards card M1 for merchant number 1 has a reward program account number M12345600. A loyalty/rewards card M2 for merchant number 2 has a reward program account number 878-0015432. A loyalty/rewards card C1 for credit card company number 1 has a reward program account number 4305877012345678. A loyalty/rewards card C2 for credit card company number 2 has a reward program account number 6011002598765432. A loyalty/rewards card L1 for loyalty/rewards card number 1 has a reward program account number L1555444. The consumer rewards-currency card profile 500 also includes a conversion of the proprietary points associated with each loyalty/rewards card A1-A2, H1-H2, R1-R2, M1-M2, C1-C2, L1 and a rewards-currency cash equivalent so that proprietary award points can be converted easily from the respective proprietary loyalty/rewards card databases A1DB-A2DB, H1DB-H2DB, R1DB-R2DB, M1DB-M2DB, C1DB-C2DB, L1DB into rewards-currency [symbol] that is stored in the rewards-currency account of the consumer.

One or more of the rewards-currency consortium 95, the financial institutions 80, and the rewards-currency management organization 120 determines the conversion ratio from proprietary award points to rewards-currency [symbol] . As demonstrated in FIG. 4, different proprietary award points, such as frequent flyer miles from the airline number 1 loyalty/rewards card A1, may have a significantly greater value than other award points such as award points from the loyalty/rewards card L1.

Once the proprietary award points are converted to rewards-currency [symbol] stored in the database 84 of the customer selected financial institution 80, the rewards-currency [symbol] , then has a value that trades like other currencies. FIG. 5 shows that the rewards-currency [symbol] has a floor value (i.e., a guaranteed minimum redemption to cash value). For example, as shown, the floor value for redemption is about $0.01. The customer may perceive the value of the rewards-currency [symbol] to be higher than the floor value because the customer may be able to obtain travel awards or gifts using the rewards-currency [symbol] that exceeds the actual cash equivalent. Thus, the customer perceived value Tₓ may vary depending on the application of the rewards-currency [symbol] , and may therefore be significantly higher than the floor value. It is also contemplated that the rewards-currency [symbol] will be traded on an exchange like other government-issued currencies (i.e., the U.S. Dollar $, the British Pound £, the Japanese Yen ¥ and the like). As shown in FIG. 5, the trade value for rewards-currency T_{y} (initial trading) or T_{w} (ongoing trading) may be even greater than a customer perceived value Tₓ.

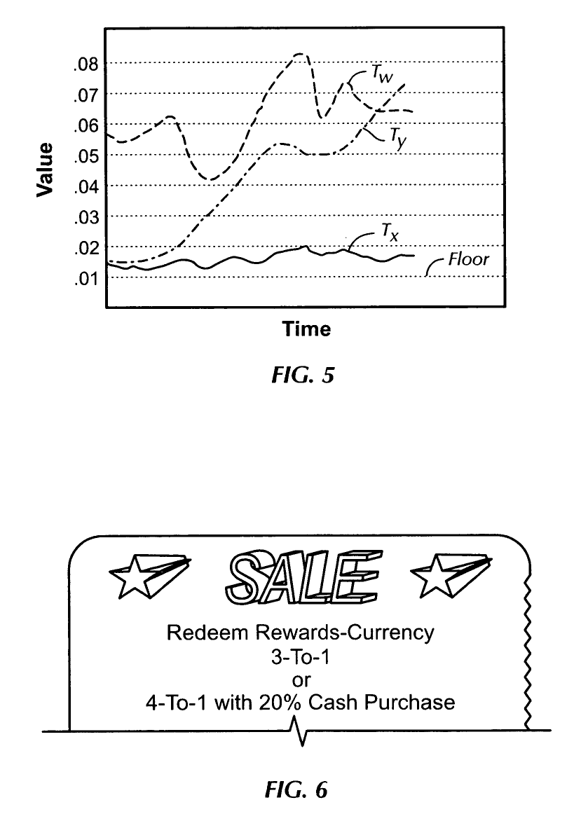

FIG. 6 shows that founding or secondary members of the rewards-currency consortium 95 may use rewards-currency [symbol] to provide discounts without “cheapening” or “diminishing” the brand as is typically the case in a sale with a large percentage discount. For example, a retailer can make offers (similar to a sale but veiled) to customers who participate in rewards-currency plans by changing the conversion ratio of rewards-currency [symbol] . For example, the consumer may be able to get a purchasing value of 3-to-1 using rewards-currency [symbol] or 4-to-1 using rewards-currency [symbol] with 20% cash. Thus, the retailer has levels of decisions to make to adjust the purchase price and incentivize the consumer to come to their store without cheapening the brand. The three levels of decision making for the retailer include (1) how much to accept in rewards-currency [symbol] ; (2) what percentage between 0.1% and 99.99% of the purchase can be made using rewards-currency [symbol] ; and (3) an option to use cash plus proprietary reward points plus rewards-currency [symbol] . Accordingly, a consumer need not redeem all their rewards-currency [symbol] and a consumer may also use existing proprietary rewards points that have not been converted to rewards-currency [symbol] to make purchases.

In order to convert the awards points to a rewards-currency [symbol] , the preferred embodiments may utilize a computer-implemented method of using one of a plurality of existing loyalty/rewards accounts A1-LN belonging to a consumer. The method includes providing account data to a compilation account service provider, such as the financial institution 80, for a plurality of existing loyalty/rewards accounts A1-LN belonging to the consumer; providing the consumer with a compilation account (e.g., rewards-currency account 123456 shown in FIG. 2) associated with the plurality of existing loyalty/rewards accounts A1-LN of the consumer; the consumer performing a loyalty/rewards transaction which qualifies for award points using one of the plurality of existing loyalty/rewards accounts A1-LN; transferring the award points from the selected loyalty/rewards account A1-LN to the compilation account 123456 of the consumer; and converting the award points transferred to the compilation account 123456 to rewards-currency [symbol] . The plurality of existing loyalty/rewards accounts A1-LN may be associated with a physical card similar to a credit card 140, but they may merely be identified by an identification account number like reward program account number of 00XXA100 that corresponds to airline number 1 shown in FIG. 4.

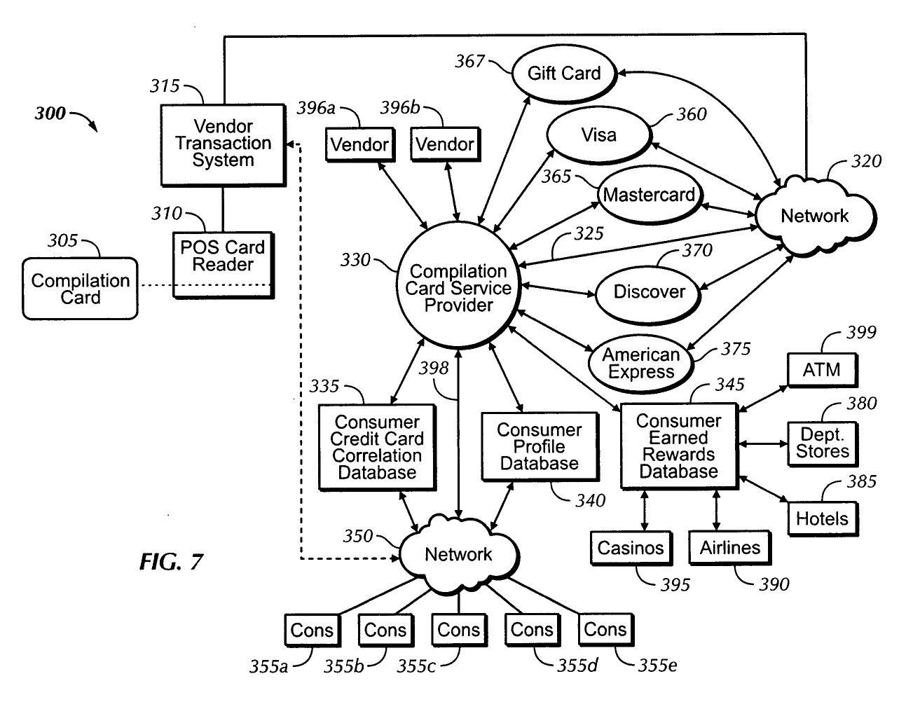

FIGS. 7-9 show a compilation card 200, 305 and a system in accordance with a second preferred embodiment of the present invention. A similar compilation card 200, 305 and system is disclosed in co-pending U.S. patent application Ser. No. 11/004,552, entitled “Method and Apparatus for Monetizing Personal Consumer Profiles by Aggregating a Plurality of Consumer Credit Card Accounts into One Card,” the entire contents of which is incorporated by reference herein.

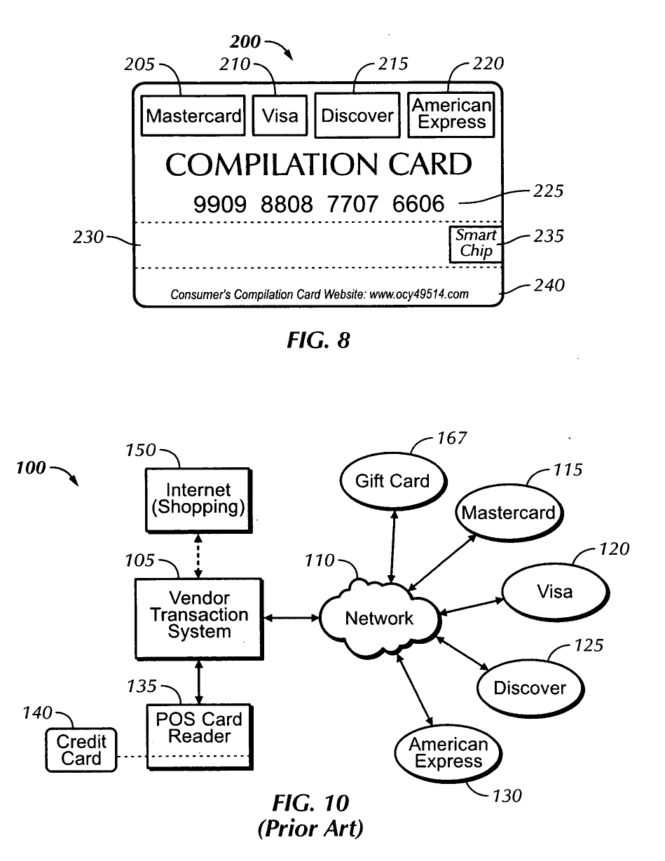

In particular, FIG. 8 shows a compilation card 200 that is obtained by a consumer 355a-355e (FIG. 7) applying for and providing information to a compilation card service provider 330. The application process may be carried out over the internet, via telephone, by mail, in person or by any other well known communication means. The compilation card service provider 330 may charge the consumer 355a-355e an annual or application fee, but it is anticipated that, at least initially, the compilation card 200 will be provided at no cost to the consumer 355a-355e. The compilation card 200 may be structured as a club or membership providing benefits to its members or subscribers. The compilation card 200 enables the consumer 355a-355e to access any one of a plurality of credit card accounts and loyalty/rewards card accounts that are similar to the first preferred embodiment. The compilation card 200 does not interfere with the use of individual credit cards 140 and individual loyalty/rewards cards A1-LN. The compilation card 200 is not a credit card or loyalty/rewards card, per se, but rather a means for accessing the consumer's existing credit card accounts and loyalty/rewards card accounts to carry out credit card and loyalty/rewards card transactions using one of the account numbers associated with those existing accounts.

The compilation card 200, in conjunction with the compilation card service provider 330, acts as an intermediary to determine which of the consumer's existing accounts that are registered with the compilation card service provider 330, should be utilized to carry out a particular credit card or reward transaction based upon a consumer profile and preferences established by the consumer 355a-355e. The predefined consumer preferences may include selecting a default existing loyalty/rewards account to use for a particular transaction type. The predefined consumer preferences may also include selectively overriding the default existing loyalty/rewards account and using another existing loyalty/rewards account when the other existing loyalty/rewards account offers a promotion. A promotion may include additional loyalty/rewards points/miles/currencies/credits, a discount on the transaction, a prize, a gift, cash-back and a donation.

The predefined consumer preferences may also include selection of a charitable organization to which to make a donation from the compilation account, such as 123456, that includes one of a percentage of the common rewards-currency [symbol] , an amount of common rewards-currency [symbol] , a cash equivalent amount of common rewards-currency [symbol] and revenue sharing on merchant commissions. Any number of charities may be listed to which the consumer 355a-355e can choose to direct a percentage or amount of earned rewards-currency [symbol] to as a donation.

The compilation card 200 preferably has emblems representing various credit card and loyalty/rewards card companies such as MasterCard® 205, Visa® 210, Discover® 215, American Express® 220 on the surface of the card 200 and/or various loyalty/rewards programs such as those provided by airlines (i.e., American Airlines®, US Airways®, United Airlines®), hotels (i.e., Holiday Inn®, Hilton®, Marriott®), rental car companies (i.e., Hertz®, Budget®, National®, Enterprise®), retail chains (i.e., Home Depot®, Sears®, Lowes®), supermarkets, coffee shops and the like. The emblems 205, 210, 215, 220 may be customized for each individual consumer 355a-355e based on the particular existing credit card accounts that the consumer 355a-355e has registered with the compilation card service provider 330 or the emblems may be generic in that they simply represent those companies that the compilation card service provider 330 carries out transactions with irrespective of which accounts a given consumer 355a-355e actually subscribes or configures to be associated with their respective account. Below the emblems 205, 210, 215, 220 is the name of the compilation card 200 and/or the compilation card service provider 330 (such as the financial institution 80) which may vary if one or more service providers 330 or different types of compilation card 200 are established and a compilation account number 225. The compilation card service provider 330 may generate additional income by leasing or charging a display fee for displaying emblems representing various credit card and loyalty/rewards card companies on the compilation card 200.

The compilation account number 225 serves as a trigger to the direct credit card transactions and loyalty/rewards card transactions associated with the use of the compilation card 200 to the compilation card service provider 330 or financial institution 80. The compilation card 200 also includes a magnetic stripe or strip (“mag-stripe”) 230 on the surface of the card and preferably a smart chip 235 to provide security. The mag-strip 230 includes data such as an American Banking Association (ABA) banking identification number (BIN) which provides routing instructions for data through a banking or other dedicated transaction network 320. It is contemplated that the mag-strip 230 may include all the necessary data for a transaction request thereby negating the need for the smart chip 235.

The compilation card 200 may be a smart card having a smart chip 235. The compilation card 200 may be a secured smart card that does not include a visible indication of the consumer's name on the surface of the card. The consumer's identity is validated through the use of the smart chip 235 while maintaining the privacy of the identity of the consumer 355a-355e. The smart chip 235 may incorporate or operate in conjunction with other security features, such as an image of the consumer 355a-355e using the card, fingerprint validation, personal identification number (PIN) code, passwords, or the like. The smart chip 235 may also contain information associated with the consumer's existing credit card accounts and sufficient artificial intelligence required to select one of the accounts to charge a transaction made using the compilation card 200. For example, the smart chip 235 may include a default credit card account number to charge a transaction when the compilation card service provider 330 is inoperable or when the vendor is unable or does not desire to use the compilation card service provider 330. Thus, the compilation card 200 can be used independently of the compilation card service provider 330 to partially provide some benefit to the consumer 355a-355e. The smart chip 235 may also store personal information about the consumer 355a-355e, such as information related to the consumer's health, driving record, financial data, work identification and/or data, computer access (e.g., passwords), etc., which can be accessed with the authorization of the consumer 355a-355e. The compilation card 230 is not limited to mag-stripe and smart-chip technologies and may utilize any equivalent technology such as radio frequency identification (RFID) or the like.

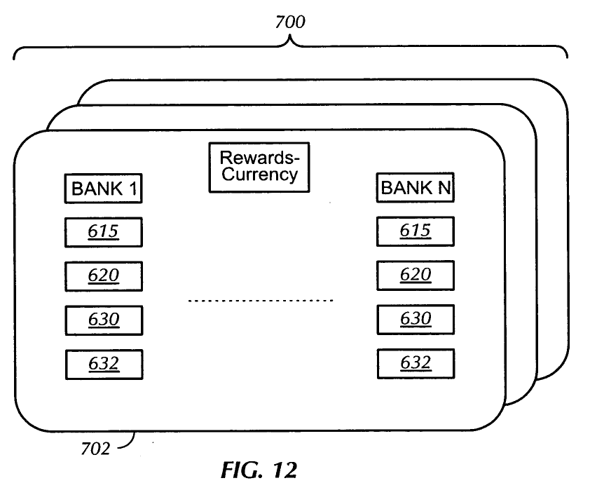

The compilation card 200 also provides website information 240, which identifies a website or portal 700 (FIG. 12) assigned to the individual consumer 355a-355e at which a vendor may obtain marketing information about the consumer 355a-355e, preferably at a cost specified by the consumer 355a-355e. There are different levels of information that can be purchased. For example, the vendor may pay a small fee for basic information, an increased fee for intermediate levels of information and a large fee for extensive aggregated information about consumer purchasing habits. The shared-data may be, to some extent, controlled by the consumer 355a-355e who selects what level of information can be sold to vendors and marketing companies. The consumer 355a-355e also shares in the fees paid, along with the rewards-currency management organization 120 (FIG. 1) or compilation card service provider 330 (FIG. 7).

FIG. 7 shows a compilation card system and/or apparatus 300 for implementing the features of a compilation card 305 in accordance with the second preferred embodiment of the present invention, similar to the compilation card 200 described above. The compilation card apparatus 300 includes a card reader 310 (e.g., a point-of-sale or POS terminal), a vendor transaction system 315, and a network 320. The network 320 maybe connected directly to a compilation card service provider 330 via path 325. The compilation card service provider 330 may alternatively be connected to the network 320 through another intermediary provider or through other intermediary providers such as banks or transaction processors (i.e., hosting providers) like the ABA network. Preferably, the compilation card service provider 330 is a customer selected financial institution 80 similar to the first preferred embodiment. The consumers 355a-355e can perform transactions at a POS terminal 310, e.g., at a retail store, or through an on-line network 350 such as the internet by using their compilation account number 123456 and/or compilation card 305.

The compilation card service provider 330 is connected to a consumer credit card correlation database 335, a consumer profile database 340 and a consumer earned rewards database 345. Databases 335, 340 and 345 are illustrated as being separate from the compilation card service provider 330. However, these databases 335, 340, 345 can reside within systems of the compilation card service provider 330, and thus may functionally operate together as a single unit.

The consumer credit card correlation database 335 and the consumer profile database 340 are connected to the Internet 350 to permit compilation card consumers 355a-355e to access the databases 335, 340 and add or delete information used by the compilation card service provider 330 to make intelligent decisions regarding which one of a plurality of credit card accounts for each compilation card consumer 355a-355e should be used to carry out a particular transaction by setting consumer preferences.

All features and benefits of each consumer's registered credit card accounts and loyalty/rewards accounts A1-LN, such as interest rates, rewards, special incentives or the like, are automatically incorporated by the compilation card service provider 330 into each intelligent decision. The decision making process is transparent to both the consumer 355a-355e and the merchant/vendor 396a-396b, once the consumer preferences are setup. The decision making process automatically incorporates preferences including principles and guidelines that were previously designated by the consumer 355a-355e and stored in the consumer profile database 340. The databases 335, 340 are also used by the compilation card service provider 330 to determine whether certain personal information associated with the consumer 355a-355e should be provided to a merchant, and at what price it should be provided.

Referring again to FIG. 7, the compilation card service provider 330 is also connected to a plurality of credit card companies 360, 365, 370, 375 that provide credit card accounts to the consumer 355a-355e and authorize transactions using associated credit card account numbers such as a gift card 367, Visa 360, MasterCard 365, Discover 370 and American Express 375. The credit card companies 360, 365, 370, 375 are also directly connected to network 320, and thus credit card transactions that do not use the compilation card 305 are routed directly to the credit card company associated with the credit card used 360, 365, 370 or 375. Of course, various banks may provide credit cards such as their own version of MasterCard or Visa, as well.

In another embodiment, the compilation card service provider 330 functions both as a regular issuer of credit cards like Visa 360, MasterCard 365, Discover 370 and American Express 375 and also as a merchant/vendor 396a-396b. The compilation card service provider 330 will provide a direct credit card transaction with a merchant/vendor 396a-396b at the POS for the consumer 355a-355e. The transaction between the compilation card service provider 330 and the merchant/vendor 396a-396b will comport with the by-laws or regulations of the credit card organization, such as Visa 360, MasterCard 365, Discover 370 and American Express 375. Thus, the compilation card service provider 330 functions as a credit card or an ACH/debit card issuer to perform transactions with a merchant/vendor 396a-396b and the compilation card service provider 330 functions as a merchant/vendor 396a-396b to perform transactions with the plurality of existing credit card accounts CC1-CCN. Then, in accordance with the preferences of the consumer 355a-355e, the transaction can be redirected to another credit card issuer C1-CN of Visa 360, MasterCard 365, Discover 370 and American Express 375 or a financial institution 80, but the compilation card service provider 330 will function as a merchant/vendor 396a-396b in the second transaction with the other credit card issuer C1-CN. When configuring their preferences or by using their PIN, the consumer 355a-355e agrees that the secondary transaction will be a credit transaction in accordance with the by-laws and/or rules associated with the credit card issuer C1-CN. For example, if the consumer 355a-355e makes a charge at a Hilton hotel using the compilation card 305 and the consumer 355a-355e has configured their preferences to direct hotel charges to credit card issuer C1, the compilation card provider 330 first completes a standard credit card transaction with the Hilton Hotel functioning as a credit card issuer, and then, the compilation card provider 330 submits a transaction to credit card issuer C1 with the compilation card provider 330 functioning as a merchant/vendor 396a-396b. The transaction may appear on the CC1 credit card statement as something like “Compilation Card Provider at the Hilton Hotel.” Preferably, the compilation card provider 330 has pre-negotiated relationships with the other credit card issuer C1-CN and/or other financial institution 80 to perform transactions with reduced fees. Optionally, the compilation card provider 330 has direct communication with the other credit card issuer C1-CN and/or other financial institution 80 to perform the secondary transactions without the need for credit card acquirer or other network transaction fees.

A computer-implemented method of using one of a plurality of existing credit accounts CC1-CCN belonging to the consumer 355a-355e includes providing account data to a single compilation card service provider 330 about the plurality of existing credit accounts CC1-CCN belonging to the consumer 355a-355e and providing the consumer 355a-355e with the compilation account 305 associated with the plurality of existing credit accounts CC1-CCN of the consumer 355a-355e. references of the consumer that determine selection of one of the plurality of existing credit accounts belonging to the consumer are stored. The consumer 355a-355e performs a primary credit transaction using the compilation account 305. A secondary credit transaction related to the primary transaction is performed between the compilation account 305 at the compilation account service provider 330 and one of the plurality of existing credit accounts CC1-CCN based on the stored preferences of the consumer.

The consumer earned rewards database 345 maintains up-to-date information on rewards earned by the consumer 355a-355e accessing registered credit card accounts through the use of the compilation card 305. The consumer rewards database 345 may be accessed by vendors such as department stores 380, hotels 385, airlines 390, and casinos 395 for redemption of the rewards by the consumer 355a-355e, or to determine offers to be presented to the consumer 355a-355e. The compilation card 305 may also be used as an automated teller machine (ATM) card or debit card to retrieve cash from an ATM 399 that the consumer 355a-355e accumulated using the compilation card 305. The compilation card service provider 330 can also convert or exchange non-cash rewards, such as frequent flyer miles, into cash which can then be accessed through ATM 399 or used as a method of payment for merchandise through at a premium exchange rate the Internet 350 or when visiting a merchant/vendor 396a-396b. Special deals or incentives providing higher exchange rates for rewards earned through the use of the compilation card may be negotiated by the compilation card service provider 330 on behalf of the consumer 355a-355e. As mentioned above, in order to convert the awards points such as frequent flier miles, to a rewards-currency [symbol] , that can be redeemed as cash or redeemed at other business entities 380, 385, 390, 395, the preferred embodiments may utilize a computer-implemented method of using one of a plurality of existing loyalty/rewards accounts A1-LN belonging to a consumer 355a-355e to calculate and track such a conversion.

The consumer 355a-355e and the compilation card service provider 330 can earn additional revenue by screening e-mail advertisements and offers received by vendors 396a, 396b, and allowing the e-mails to be forwarded to compilation card consumers 355a-355e via path 398 and the Internet 350. The vendors 396a, 396b can be required to pay a fee, which is shared by the compilation card service provider 330 and the consumer 355a-355e, in return for permitting the vendors' 396a, 396b e-mails to be sent to the consumer 355a-355e. The consumer 355a-355e may indicate in the consumer profile database 340 which type of offers the consumer 355a-355e is interested in and is willing to receive via e-mail. The compilation card service provider 330 can either maintain the confidentiality of the consumer's current e-mail address and/or establish a new compilation card e-mail address solely for the purpose of generating revenue for the compilation card service provider 330 and the consumer 355a-355e. The compilation card service provider 330 also enables the consumer 355a-355e to designate compensation levels required before e-mail messages will be accepted for delivery. The consumer 355a-355e may specify different “prices” for different types of e-mail messages. The vendor 396a-396b may review the consumer's prices by visiting the website of the consumer's compilation card provider 330 or by using the consumer's account number to search a database (such as consumer credit card correlation database 400 shown in FIG. 4) established by the compilation card service provider 330. Thus, the privacy of the consumer 355a-355e is maintained.

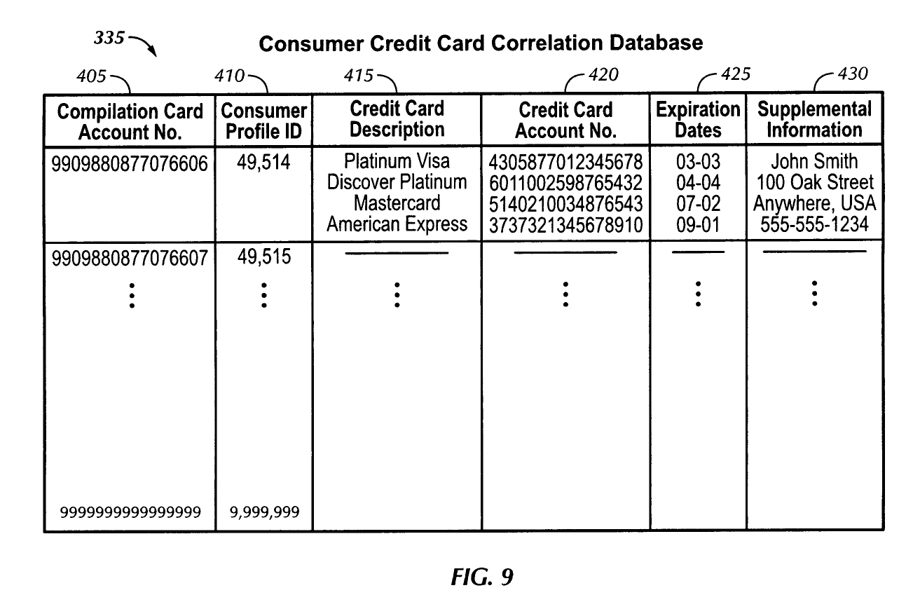

FIG. 9 shows a consumer credit card correlation database 335 that includes the compilation card account number record 405 of each consumer using the compilation card 220, 305, a consumer profile identification (ID) field 410 used to access each compilation card consumer's profile, a plurality of credit card descriptions of the consumer's credit card accounts 415 (e.g., the type and issuer of each credit card), the associated (existing) credit card account numbers 420 and expiration dates 425, and supplemental information 430 about the consumer and/or the consumer's credit card accounts, such as credit card limits, consumer name, address and telephone number, or the like. The compilation card account number data 405 and consumer profile ID data 410 are provided by the compilation card service provider 330. All of the other information 415, 420, 425, 430 may be obtained from the consumer through the use of the Internet 350, telephone, mail or other well known communications means. The information may be obtained by prompting the consumer 355a-355e for particular information, or by hosting questionnaires that require a response from the consumer 355a-355e.

For example, account number “9909 8808 7707 6606” (i.e., the compilation card account) has consumer profile identification number “49,514” and four existing credit card accounts (Platinum Visa®, “4305 8770 1234 5678” expiration date 03-03; Discover® Platinum, account number “6011 0025 9876 5432”expiration date 04-04; MasterCard®, account number “5140 2100 3487 6543” expiration date 07-02; and American Express, account number “3737 3213 4567 8910”expiration date 09-01), associated therewith. Additionally, the supplemental information 430 associated with account number “9909 8808 7707 6606” can include the full name and address of the card holder, or as shown, “John Smith, 100 Oak Street, Anywhere, USA (555) 555-1234.” All of the information shown in FIG. 4, relating to the consumer's loyalty/rewards accounts A1-LN is also linked to the compilation card account number 405 so that the compilation card 305 provides the consumer with a unitary card 305 that includes the functions of a plurality of credit card and loyalty/rewards accounts A1-LN.

The consumer's preferences and criteria may include particular limitations to the monetary value of transactions and credit card balances for each registered credit card account. Thus, if the consumer's Bank of America® MasterCard account has a balance set by the consumer 355a-355e in the consumer profile database or correlation database that exceeds $4,500.00, the account would not be considered for future transactions using the compilation card 200, 305 even if there was sufficient credit to warrant additional purchases. The consumer's preferences and criteria could also be based on numerous other parameters such as a type of transaction, a vendor, a type of vendor, a time of the year when the compilation card is being used, a reward preference, a lifestyle preference and the like.

The stored consumer preferences may include selecting a default existing credit card account CC1-CCN among the plurality of existing credit card accounts CC1-CCN to use for a particular transaction type. The type of transaction may be distinguished based upon business or personal use or by a vendor type such as a retail purchase, a gas station purchase, a supermarket purchase, a travel ticket purchase, a hotel/motel payment, a services payment or the like. The stored consumer preferences may also include selectively overriding the default existing credit card account CC1-CCN and using another existing credit card account CC1-CCN when the other existing credit card account CC1-CCN offers a promotion. A promotion includes, for a particular transaction type, one of additional loyalty/rewards points/miles/currencies/credits, a discount on the transaction, a prize, a gift, cash-back and a donation.

The consumer's preferences and criteria may be obtained from the consumer 355a-355e through the use of the Internet 350, telephone, mail or other well known communications means. The consumer's preferences and criteria may be obtained by prompting the consumer 355a-355e for particular information, or by hosting questionnaires that require a response from the consumer 355a-355e.

In another embodiment of the present invention, the compilation card service provider 330 enables the consumer 355a-355e to be in charge of setting the price of access to personal information stored in the consumer profile database 340 or elsewhere. Individual prices may be set for small portions of the personal information. This enables the consumer 355a-355e to earn revenue and take charge of the distribution and accessibility provided to merchants of information such as economic, demographic, and even the consumer's identity, which as previously mentioned is not revealed on the surface of the compilation card 200, 305. Revenue earned through the use of the compilation card 200, 305 would be shared with the compilation card service provider 330 in accordance with a previously established agreement. The compilation card service provider 330 will be able to leverage the power of compilation card consumers 355a-355e with merchants/vendors 396a-396b.

In another embodiment of the present invention, the compilation card service provider 330 establishes an environment in which merchants/vendors 396a-396b have ample opportunity to generate new business and expand their customer base. Customers 355a-355e are drawn to a portal 700 (FIG. 12) of the compilation card service provider 330 that provides convenient and extensive benefits and services to compilation card consumers 355a-355e, such as access to banks, bill payment services, investment houses, credit information, frequent flyer mileage, or the like. The portal 700 of the compilation card service provider 330 is user-friendly and is accessible by computers, internet kiosks, laptops, personal digital assistants (PDAs), telephones, or the like. Compilation card consumers 355a-355e are also drawn to their individual websites 702 to access offers sent by merchants/vendors 396a-396b. Merchants/vendors 396a-396b benefit by being exposed to a large consumer base which enhances their chances of procuring new customers.

In another embodiment, the rewards-currency management organization 120 or compilation card service provider 330 permits consumers 355a-355e to direct rewards-currency [symbol] or the cash equivalent thereof to 529K accounts, 401K accounts, pension plans, investment vehicles, charitable organizations or the like.

In another embodiment, the rewards-currency management organization 120 or compilation card service provider 330 gives the consumers 355a-355e an opportunity to earn extra income by providing a user-friendly forum for the consumers 355a-355e to receive a share of revenue generated by a service provider that manages the consumer's credit card and/or loyalty/rewards card transactions and offers merchants access to the consumer's personal transaction information. In another embodiment, the rewards-currency management organization 120 or compilation card service provider 330 gives the consumers 355a-355e the power to demand specific levels of compensation for providing such personal information.

In another embodiment, the rewards-currency management organization 120 or compilation card service provider 330 expands the opportunity for merchants/vendors 396a-396b to attract new customers by providing a portal 700 that draws consumers 355a-355e and provides a medium for merchants/vendors 396a-396b to entice the consumers with offers. The consumers 355a-355e can selectively earn rewards-currency [symbol] by reviewing e-mail promotions, answering surveys, reading pop-up advertisements that are tracked and the like. Unlike spam, a consumer 355a-355e opts in to the e-mail promotions and does not have to read them, in which case the consumer 355a-355e simply does not earn rewards-currency [symbol] .

The embodiments of the present invention are implemented so as to be complementary to existing loyalty/rewards programs. A consumer 355a-355e may elect to use proprietary award points alone or in conjunction with rewards-currency [symbol] and or cash. A consumer 355a-355e may elect to not have a particular loyalty/rewards account A1-LN associated with a compilation account 123456. A consumer 355a-355e may elect to not have award points from a particular loyalty/rewards account A1-LN automatically transfer to a compilation account 123456.

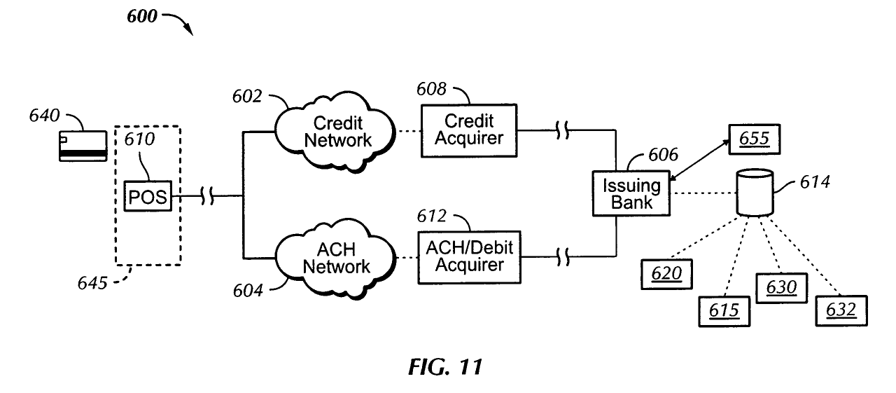

FIG. 11 shows a system for managing consumer accounts and transactions 600 by aggregating a plurality of consumer accounts in accordance with a third preferred embodiment of the present invention. The system 600 includes a credit card network 602 and an ACH/debit network 604 for communicating transaction information from one or more point of sale (POS) terminals 610 through a credit acquirer 608 and ACH/debit acquirer 612, respectively, to an issuing bank 606. A consumer 655 selects a particular issuing bank 606 of their choice to establish one or more of a first credit account 615, a second credit account 620, a checking account 630 and a savings account 632. The first and second credit accounts 615, 620 may be Visa, MasterCard, American Express, the issuing bank's private charge and the like. The issuing bank 606 maintains a database record 614 or a particular consumer's accounts and consumer preferences.

A compilation card 640 is obtained by a consumer 655 applying for and providing information to the issuing bank 606. The application process may be carried out over the internet 350, via telephone, by mail, in person or by any other well known communication means. The issuing bank 606 may charge the consumer 655 an annual or application fee, but it is anticipated that the issuing bank 606 will be provided at no cost to the consumer 655 because the consumer 655 maintains a plurality of accounts 615, 620, 630, 632 with the issuing bank 606. The compilation card 640 enables the consumer 655 to access any one of a plurality of credit card accounts 615, 620, 630 and bank accounts 630, 632. The compilation card 640 may also be associated with a plurality of loyalty programs and other credit card accounts A1-LN (FIG. 1) like the first preferred embodiment. The compilation card 640 does not interfere with the use of individual credit cards 140 and individual loyalty/rewards cards A1-LN. The compilation card 640 may be a credit card, a debit card, a check card or a loyalty/rewards card, or alternatively may be a means for accessing the consumer's existing credit card accounts 615, 620, bank accounts 630, 632 and loyalty/rewards card accounts A1-LN to carry out credit card and loyalty/rewards card transactions using one of the account numbers associated with those existing accounts 615, 620, 630, 632, A1-LN.

The consumer 655 can select preferences for management of their accounts 615, 620, 630, 632 with the issuing bank 606 in person, by telephone, by computer access and the like. The preferences for management include determining when to use a particular account 615, 620, 630, 632 for a given transaction. The consumer 655 can configure their preferences to make all credit transactions be charged to the first credit account 615 or to make all credit transactions be charged to the second credit account 620. The consumer 655 can configure their preferences to make all credit transactions below a certain value be charged to one credit account 615, 620 and all credit transactions above a certain value to be charge to another credit account 615, 620. The consumer 655 can configure their preferences to make all credit transactions be charged to one credit account 615, 620 until that credit account 615, 620 reaches a preset limit, then make subsequent credit transactions be charged to the other credit account 615, 620. Furthermore, the consumer 655 can configure their preferences to make credit transactions be charged to a different credit account 615, 620 so as to optimize a loyalty reward for a given transaction or for a particular time period similar to the first preferred embodiment. Thus, one of the compilation card or account 640 and the compilation account service provider (issuing bank) 606 is configured to select one of existing credit card accounts 615, 620, bank accounts 630, 632 and loyalty/rewards card accounts A1-LN among the respective plurality of existing credit card accounts 615, 620, he respective plurality of bank accounts 630, 632 and he respective plurality of loyalty/rewards card accounts A1-LN to which to charge a particular credit card transaction, bank account transaction or credit a particular loyalty/rewards account transaction based on the predefined preferences of the consumer 655.

Because the consumer 655 has a plurality of accounts 615, 620, 630, 632 with one issuing bank 606, the consumer 655 can also configure their preferences to direct an ACH/debit transaction performed using a PIN at the POS terminal 610 to be treated as a credit transaction after the transaction is received at the issuing bank 606. Normally, a credit transaction is processed from the POS terminal 610 through the credit network 602 and the credit acquirer 608 before reaching the issuing bank 606. The credit acquirer 608 typically charges an interchange fee that is a few percent of the overall transaction. The merchant 645 and/or consumer 655 who makes the POS transaction ultimately pays that fee because it is deducted from the overall purchase price when the daily transactions are settled. An ACH/debit transaction, on the other hand, is processed from the POS terminal 610 through the ACH network 604 and the ACH/debit acquirer 612 before reaching the issuing bank 606. The ACH/debit acquirer 612 typically charges a flat fee or fixed fee for the transaction and the issuing bank 606 sometimes charges a small interchange fee, but more often the interchange bank 606 foregoes the interchange fee for customer loyalty purposes. A benefit of having a plurality of accounts 615, 620, 630, 632 with one issuing bank 606 is that the consumer 655 can configure their preferences so that an ACH/debit transaction gets directed to their one of their credit accounts 615, 620 in the back-office of the issuing bank 606. Thus, if the consumer 655 makes an ACH/debit transaction at the POS terminal 610, the transaction can be treated as an ACH/debit transaction through the ACH/debit network 604 and the ACH/debit acquirer 612 even though at the issuing bank 606 it may ultimately applied to a credit account 615, 620 of the consumer 655 based on the predefined preferences of the consumer 655.

Of course, the consumer 655 could arrange their preferences so that only ACH/debit transactions of a certain type should be treated as credit transactions. The consumer 655 may want all cash withdraws to be true ACH/debit transactions from one of their checking 630 and savings 632 accounts. The consumer 655 can configure their preferences so that all purchases made at food stores as ACH/debit transactions are treated as true ACH/debit transactions, but all other ACH/debit transactions are treated, in the back-office of the issuing bank 606, as credit transactions. Similar to the preference choices mentioned above, the consumer 655 can configure their preferences so that ACH/debit transactions less than a certain dollar amount are treated as true ACH/debit transactions using one of their checking and savings accounts 630, 632 or to be directed to a particular credit account 615, 620. Likewise, the consumer 655 can configure their preferences so that ACH/debit transactions greater than a certain dollar amount are treated as true ACH/debit transactions using one of their checking and savings accounts 630, 632 or to be directed to a particular credit account 615, 620. The consumer 655 configure their preferences so that ACH/debit transactions are charged to a particular credit account 615, 620 so as to optimize a loyalty reward for a given transaction or for a particular time period similar to the first preferred embodiment.

By consumers 655 using their compilation cards 640 to perform ACH/debit transactions while having the transaction actually treated as credit transactions to the issuing bank 606, the issuing bank 606 can provide the consumer 655 with additional loyalty rewards for the credit accounts 615, 620 by the cost savings in the overall transaction compared to a true credit transaction. Since the consumer 655 can get additional rewards benefits while still enjoying the benefit of the float of a credit transaction, the consumer 655 will have the motivation to use the credit accounts 615, 620 of the issuing bank 606 that provides this service. So, even though the issuing bank 606 will forgo a certain amount of interchange fee compared to a true credit transaction, the issuing bank 606 will reap the benefit of more of the activities of the consumer 655 including the interest on the credit accounts 615, 620.

Optionally, the compilation card 640 may have a plurality of different PIN numbers associated therewith and the consumer 655 can utilize a particular PIN for a particular transaction. For example, if the consumer 655 wishes the transaction to be treated as a true ACH/debit transaction, the consumer 655 uses a first PIN, and if the consumer 655 wishes the transaction to be directed to a credit account 615, 620, the consumer 655 uses a second PIN. The consumer 655 can configure different accounts to be associated with different PIN numbers using their account preferences. For example, the consumer 655 can perform a debit/PIN transaction using the compilation account by entering one of the first PIN and the second PIN and, at the compilation account service provider (issuing bank) 606, the debit/PIN transaction is treated as one of (i) a debit transaction directed to the existing checking/savings account 630, 632 when the first PIN is entered by the consumer 655 and (ii) a credit transaction directed to one of the plurality of existing credit accounts 615, 620 when the second PIN is entered by the consumer wherein the credit transaction is directed to one of the plurality of existing credit accounts 615, 620 based on the stored preferences of the consumer 655.

An ACH/debit transaction benefits the merchants 645 as well who will ultimately pay lower interchange fees from an ACH/debit acquirer 612 (fixed fee) as compared to a credit acquirer 608 (percentage of transaction fee). Thus, the merchant 645 also has the incentive to provide the consumer 655 with additional loyalty rewards for ACH/debit transactions. ACH/debit transactions are also more desirable for a merchant 645 because the settlement is almost instant.

The issuing banks 606 may offer incentive programs that merchants 645 can register with so that the issuing bank 606 and merchants combine the cost savings of the ACH/debit transaction which is mutually beneficial to provide a combined higher loyalty reward to the consumer 655 such as with increased loyalty or rewards points or universal rewards-currency [symbol] for making ACH/debit transactions at the POS 610 using the compilation card 640 of the issuing bank 606.

One difference between an ACH/debit transaction and a credit transaction is disputes resolution. Credit card issuers 606 have a dispute resolution system that permit a consumer 655 to dispute a particular credit transaction and the issuing bank 606 will charge-back the merchant 645 until the dispute is resolved, whereas an ACH/debit transaction is almost instantly final between the consumer 655 and merchant 645. But, because of the fee savings, the issuing bank 606 may provide an insurance policy for disputed transactions. The merchants 645 may also agree with the issuing banks 606 to treat disputes for ACH/debit transactions in a fashion similar to present credit transactions so that all parties can reap the benefits of the ACH/debit system.

In another embodiment, the consumer 655 has a plurality of accounts 615, 620, 630, 632 with one issuing bank 606, as well as a plurality of accounts 615, 620, 630, 632 at other issuing banks 606 and/or a plurality of credit cards CC1-CCN from other credit card companies CC1-CCN. The consumer 655 can configure their preferences with the primary issuing bank 606 to direct an ACH/debit transaction performed using a PIN at the POS terminal 610 to be treated as a credit transaction after the transaction is received at the primary issuing bank 606, i.e., the issuing bank 606 for the particular card 640 being used in the transaction, to accounts with another issuing bank 606 and/or to other credit cards CC1-CCN. Optionally, the issuing bank 606 has established relationships with a plurality of other issuing banks 606 and/or other credit card companies CC1-CCN to facilitate reduced transaction fees by eliminating the more expensive credit acquirer 608 from the transaction. There may be some fees for inter-bank transactions and bank to credit card company transactions, but these fees are preferably fixed-fee or a much smaller pre-negotiated fee than that demanded by the credit acquirers 608.

Optionally, the compilation card 640 may have a plurality of different PIN numbers associated therewith and the consumer 655 can utilize a particular PIN for a particular transaction in combination with the predefined consumer preferences. For example, if the consumer 655 wishes the transaction to be treated as a true ACH/debit transaction at their primary issuing bank 606, the consumer 655 uses a first PIN. If the consumer 655 wishes the transaction to be treated as a true ACH/debit transaction at another issuing bank 606, the consumer 655 uses a second PIN. If the consumer 655 wishes the transaction to be directed to a credit account 615, 620 at their primary issuing bank 606 or another issuing bank and/or to other credit cards CC1-CCN, the consumer 655 uses a third PIN. The consumer 655 can configure different accounts 615, 620, 630, 632, CC1-CCN and different transactions to be associated with different PIN numbers using their account preferences. The predefined consumer preferences can then select among the plurality of different accounts 615, 620, 630, 632, CC1-CCN based upon the predefined configured preferences. thus the PIN numbers can be used as a security measure to access the plurality of different accounts 615, 620, 630, 632, CC1-CCN and can also optionally select among groups of the different accounts 615, 620, 630, 632, CC1-CCN. For example, by selecting the third PIN, the heuristics only decide which credit account 615, 620, CC1-CCN to charge against based upon the predefined consumer preferences and the transaction type.

A computer-implemented method of performing a debit/PIN or ACH/debit transaction using an existing credit account 615, 620, CC1-CCN belonging to a consumer 655 includes providing account data to a compilation account service provider (issuing bark) 606 for the existing credit account 615, 620, CC1-CCN belonging to the consumer 655 and providing the consumer 655 with a compilation account 640 associated with the existing credit account 615, 620, CC1-CCN of the consumer 655. The consumer 655 performs a debit/PIN transaction using the compilation account 615, 620, CC1-CCN. At the compilation account service provider and/or issuing bank 606, the debit/PIN transaction is treated as a credit transaction directed to the existing credit account 615, 620, CC1-CCN based upon the predefined preferences of the consumer 655.

Another computer-implemented method of performing a debit/PIN transaction using one of a plurality of existing credit accounts 615, 620, CC1-CCN belonging to a consumer 655 includes providing account data to a compilation account service provider (issuing bank) 606 about the plurality of existing credit accounts 615, 620, CC1-CCN belonging to the consumer 655 and providing the consumer 655 with a compilation card 640 associated with the plurality of existing credit accounts 615, 620, CC1-CCN of the consumer 655. The compilation card 640 has at least one PIN associated therewith. The consumer 655 performs a debit/PIN transaction using the compilation card 640. At the compilation account service provider 606, the debit/PIN transaction is treated as a credit transaction directed to one of the plurality of existing credit accounts 615, 620, CC1-CCN based upon the predefined preferences of the consumer 655.

Another computer-implemented method of performing a debit/PIN transaction using one of an existing credit account 615, 620, CC1-CCN and an existing checking/savings account 630, 632 belonging to a consumer 655 includes providing account data to a compilation account service provider (issuing bank) 606 for the existing credit account 615, 620, CC1-CCN and the existing checking/savings account 630, 632 belonging to the consumer 655 and providing the consumer 655 with a compilation card 640 associated with the existing credit account 615, 620, CC1-CCN and the existing checking/savings account 630, 632 of the consumer 655. The compilation card 640 has a first PIN and a second PIN associated therewith. The consumer 655 performs a debit/PIN transaction using the compilation card 640 by entering one of the first PIN and the second PIN. At the compilation account service provider 606, the debit/PIN transaction is treated as one of (i) a credit transaction directed to the existing credit account 615, 620, CC1-CCN and (ii) a debit transaction directed to the existing checking/savings account 630, 632, depending on which one of the first PIN and second PIN is entered by the consumer.

Another computer-implemented method of performing a debit/PIN transaction using one of a plurality of existing credit accounts 615, 620, CC1-CCN and an existing checking/savings account 630, 632 belonging to a consumer 655 includes providing account data to a compilation account service provider (issuing bank) 606 about the plurality of existing credit accounts 615, 620, CC1-CCN and the existing checking/savings account 630, 632 belonging to the consumer 655 and providing the consumer 655 with a compilation card 640 associated with the plurality of existing credit accounts 615, 620, CC1-CCN and the existing checking/savings account 630, 632 of the consumer 655. The compilation card 640 has a first PIN and a second PIN associated therewith. The consumer 655 performs a debit/PIN transaction using the compilation card 640 by entering one of the first PIN and the second PIN. At the compilation account service provider (issuing bank) 606, the debit/PIN transaction is treated as one of (i) a debit transaction directed to the existing checking/savings account 630, 632 when the first PIN is entered by the consumer and (ii) a credit transaction directed to one of the plurality of existing credit accounts 615, 620, CC1-CCN when the second PIN is entered by the consumer 655. The credit transaction is then directed to one of the plurality of existing credit accounts 615, 620, CC1-CCN based on the stored preferences of the consumer 655.

FIG. 12 is a screen shot of a consumer accessible portal 700 for defining consumer account management preferences in accordance with a fourth preferred embodiment of the present invention. The portal 700 is user-friendly and is accessible by computers, internet kiosks, laptops, personal digital assistants (PDAs), telephones, or the like. The portal 700 provides a consumer 655 (FIG. 11) with access to a plurality of accounts 615, 620, 630, 632 (FIG. 11) and A1-LN (FIG. 1) so that the consumer 655 can monitor account activity and balances, configure preferences and track universal rewards-currency [symbol] balances. The consumer 655 configures their personal portal page 702 with accounts from a one or more banks BANK 1-BANK N including a plurality of accounts 615, 620, 630, 632 at each bank. The consumer 655 can also set preferences for their compilation card 640 (FIG. 11) or for each and/or any of their other loyalty and credit cards A1-LN (FIG. 1). Thus, the portal 700 combines the features and benefits of the first through third preferred embodiments. Additionally, the portal 700 can be used to configure internet payments and credit transactions directly without the compilation card 640 using any of the plurality of consumer accounts 615, 620, 630, 632, A1-LN.

A method of managing a plurality of existing consumer accounts 615, 620, 630, 632, A1-LN includes providing account data to a compilation account service provider (issuing bank) 606 about the plurality of existing credit accounts 615, 620, CC1-CCN and the existing checking/savings account 630, 632 belonging to the consumer 655 and providing the consumer 655 with a compilation card 640 associated with the plurality of existing credit accounts 615, 620, CC1-CCN and the existing checking/savings account 630, 632 of the consumer 655. A user accessible internet-based portal for managing the compilation account is provided. The account data is inputted by the consumer 655, through the internet-based portal 700, to the compilation account service provider 606 about the plurality of existing credit accounts 615, 620, CC1-CCN and the existing checking/savings account 630, 632 belonging to the consumer 655. Preferences are set by the consumer 655, through the internet-based portal 700, that determine which of the plurality of existing credit accounts 615, 620, CC1-CCN and/or the existing checking/savings account 630, 632 belonging to the consumer 655 to use for a particular type of transaction. The consumer performs one of a credit transaction and a debit/PIN transaction using the compilation account 640. At the compilation account service provider 606, the respective one of the credit transaction and the debit/PIN transaction is treated as a credit transaction directed to a particular one of the plurality of existing credit accounts 615, 620, CC1-CCN or as a true debit/PIN transaction directed to a particular one of the existing checking/savings accounts 630, 632 based on the preferences at least partially set by the consumer 655.

The stored consumer preferences may include selecting a default existing credit card account 615, 620, CC1-CCN among the plurality of existing credit card accounts 615, 620, CC1-CCN to use for a particular transaction type. The type of transaction may be distinguished based upon business or personal use or by a vendor type such as a retail purchase, a gas station purchase, a supermarket purchase, a travel ticket purchase, a hotel/motel payment, a services payment or the like. The stored consumer preferences may also include selectively overriding the default existing credit card account 615, 620, CC1-CCN and using another existing credit card account 615, 620, CC1-CCN when the other existing credit card account 615, 620, CC1-CCN offers a promotion. A promotion includes, for a particular transaction type, one of additional loyalty/rewards points/miles/currencies/credits, a discount on the transaction, a prize, a gift, cash-back and a donation.

The internet-based portal 700 may also include hyperlinks or links to promotional offers. The links permitting the consumer 655 to at least temporarily override the stored preferences in order to take advantage of one or more of the promotional offers. Likewise, the consumer 655 may receive e-mails from collaborating members about promotional offers which include a link or a response button permitting the consumer 655 to at least temporarily override the stored preferences in order to take advantage of one or more of the promotional offers. The consumer 655 may also receive messages or text-messages on their cellular phones, PDA's, BlackBerry devices or the like, from collaborating members about promotional offers which include a link or a response button permitting the consumer 655 to at least temporarily override the stored preferences in order to take advantage of one or more of the promotional offers. Thus, the consumer 655 can make temporary decisions on the fly or during real-time.

Another embodiment of the present invention comprises a computer-implemented method of using email and/or other forms of electronic communications to send a message to a wireless communications device, like personal digital assistant (PDA), a Blackberry, a cell phone, and/or computer offering a specific special, program offering, merchant or manufacture promotional offering that is targeted to the user. The user decides to accept or decline the offering by responding to the electronic communications, and based on the decision and response at least temporarily resets, overrides or changes their preferences based on the offering.

Another embodiment of the present invention comprises a computer-implement system and methodology for tracking gift card account numbers, promotional discount codes, rain checks, refunds and allowing them to be included in the consumer preference and selection process. Thus, a single place to manage all payment types is provided including stored value cards, gift cards, internet promotional offerings and applying them to consumer preferences, use preferences and redemption. For example, if the consumer 655 makes a purchase and receives a redemption code electronically, the portal 700 provides a means of tracking the redemption code for the next applicable purchase by the consumer 655.

Another embodiment of the present invention comprises a computer-implemented method of using a database to store information and preferences on charities, schools, or nonprofits by the consumer. Based on the consumer preferences, earnings and contributions can be selectively given to these chartable organizations based on specials and/or promotional offerings based on purchasing activities, discounts or seasonal activities. As the consumer shops, redeems, carries out transactions earnings, commissions, discounts or other possible revenue streams, an allowance for donations is thereby created. As transactions take place and buying behaviors happen, donations are made to the charities of choice and/or selection based on these pre arranged agreements and terms. The donation database processes these transactions and account for the distribution of donation funds to charities.

Primarily, the portal 700 provides access to the accounts 615, 620, 630, 632, A1-LN of the consumer 655, but the portal 700 may also provide other services such as e-mail, tracking of government accounts, tracking of health-care accounts, news, loyalty/rewards data, financial data, favorite sites, search engines, family information, work information, education information, social information, sports information, entertainment or the like. The portal 700 may be structured as a club or membership providing benefits to its members or subscribers. The consumer 655 can link a plurality of different password protected data sites to their customized portal page 702. Once the individual usernames and passwords are entered into the preferences of the consumer 655, the consumer 655 can link directly to the password protected sites through the portal 700 without the need to login to each password protected site. Preferably, the portal 700 has a very high security access because so much personal information is being tracked in one location. Preferably, the portal 700 is maintained on a server that is very secure and which has an extensive infrastructure of interconnectivity with financial, consumer and merchant communication networks.

The portal 700 may be maintained on the server of a consumer credit reporting company such as Equifax, TransUnion and Experian. The consumer credit reporting companies have an existing secure network which monitors and tracks a large majority of the population without being beholden to any one issuing bank 606 or credit card company.

Optionally, the portal 700 may also be maintained on the server of an issuing bank 606 (BANK 1-BANK N). The benefit to focusing on one issuing bank 606 is the reduced dependence on outside credit processors and credit acquirers 608 who charge higher fees and/or have particular requirements for using their services.

Optionally, the portal 700 may be maintained on the server of an online shopping or e-mail service such as America Online (AOL), Microsoft Network (MSN), Yahoo!, Google or the like.

The portal 700 will include data about consumers 655 who are members. The data can be traded and/or sold with the consent of the consumer 655. The consumer 655 can determine, by configuring preferences, which data about the consumer 655 will be collected and sold. For example, the consumer 655 may wish certain types of transactions to be kept private (e.g., gambling, adult-content, prescription medicines or the like) or transactions for a particular existing credit account CC1-CCN to be kept private. There are different levels of information that can be purchased. For example, the merchant/vendor 645 may pay a small fee for basic information, an increased fee for intermediate levels of information and a large fee for extensive aggregated information about consumer purchasing habits. The shared-data may be, to some extent, controlled by the consumer 655 who selects what level of information can be sold to merchants/vendors 645 and marketing companies. The consumer 655 also shares in the fees paid, along with the rewards-currency management organization 120 (FIG. 1) and/or the issuing bank 606 (FIG. 11), which can provide incentives back to the consumers 655 who are members in the form of rewards-currency [symbol] or other rewards. Since the consumer 655 and the currency management organization 120 and/or the issuing bank 606 share in the fees paid, preferably, there are no subscription or membership fees for the portal 700.

The portal 700 can be used by the consumer 655 to manage their rewards-currency [symbol] or other rewards between the issuing banks 606, financial institutions 80 or other reward/loyalty accounts A1-LN. The issuing banks 606, financial institutions 80 or other reward/loyalty accounts A1-LN may charge transaction fees for transferring rewards-currency [symbol] between different issuing banks 606, financial institutions 80 or other reward/loyalty accounts A1-LN.

Advertising space can be sold on the portal 700 which can provide incentives back to the consumers 655 who are members in the form of rewards-currency [symbol] or other rewards. Purchases made online using the portal 700 will entitle the consumer 655 to additional rewards-currency [symbol] . The consumer 655 can use the portal 700 to browse a variety of merchants 645 offering incentives in rewards-currency [symbol] as well as the value they assign to rewards-currency [symbol] in their store.

In another embodiment, the compilation card service provider and/or issuing bank 606 permits consumers 655 to direct rewards-currency [symbol] or the cash equivalent thereof to 529K accounts, 401K accounts, pension plans, investment vehicles, charitable organizations or the like.

While described above in some embodiments as being embodied in a credit card 205, 305, 640, compilation accounts in accordance with the preferred embodiments need not be. Compilation accounts can be used in card-less transactions over the internet 350 or by telephone. Furthermore, compilation accounts can be associated with personal electronic devices such as PDA's, cellular phones, pagers, universal serial bus (USB) keys, RFID tags/cards, semiconductor chips/buttons or the like without departing from the present invention.

It is contemplated that the consumer preferences will be utilized with heuristics and mined or merchant provided offers to maximize awards/loyalty points and/or prizes and/or free trips and/or free hotel nights and/or promotional gifts and/or discounts, at any given time. For example, if a consumer is close to an award of a free-airline ticket for using a particular card, the system may determine to override a smaller cash-back or discount incentive and charge the transaction to the card 615, 620, CC1-CCN that will yield the awarded airline ticket more quickly, based on the consumer's preferences. Likewise, a consumer 650 can set their preferences so that promotional offers automatically override some or all of the consumer's default preference selections depending on the offer or, the time of year, the value of the promotional offer or the like.

Embodiments of the present invention may be implemented with any combination of hardware and software. If implemented as a computer-implemented apparatus, the present invention is implemented using means for performing all of the steps and functions described above.

Embodiments of the present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

From the foregoing, it can be seen that the present invention is directed to method for managing consumer accounts and transactions by aggregating a plurality of consumer accounts and providing a consumer accessible portal for defining consumer preferences. It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

We claim:

1. A system that permits a consumer to access one of a plurality of existing credit card accounts belonging to a consumer, the system comprising:
at least one transaction network configured to route credit card or ACH/debit card transactions;
a compilation credit card being associated with the plurality of existing credit card accounts of the consumer, the compilation credit card having a compilation credit card number associated therewith; and
a compilation card service provider having a compilation card database that stores information about the plurality of existing credit card accounts belonging to the consumer and a consumer preferences database that stores predefined preferences of the consumer, the compilation card service provider having access to the plurality of existing credit card accounts, the compilation card service provider being accessible by the at least one transaction network to receive credit card transaction requests or ACH/debit card transaction requests based on the compilation credit card number,
one of the compilation credit card and the compilation card service provider being configured to select one of an existing credit card account among the plurality of existing credit card accounts to which to charge a particular transaction based on the predefined preferences of the consumer.

2. The system according to claim 1, wherein the stored preferences include selecting a default existing credit card account among the plurality of existing credit card accounts to use for a particular transaction type.

3. The computer-implemented method according to claim 2, wherein the stored preferences include selectively overriding the default existing credit card account and using another existing credit card account when the other existing credit card account offers a promotion.

4. The system according to claim 3, wherein the promotion includes, for the particular transaction type, one of additional loyalty/rewards points/miles/currencies/credits, a discount on the transaction, a prize, a gift, cash-back and a donation.

5. The system according to claim 1, wherein the compilation card service provider functions as a credit card or an ACH/debit card issuer to perform transactions with a merchant/vendor and the compilation card service provider functions as a merchant/vendor to perform transactions with the plurality of existing credit card accounts.

6. The system according to claim 1, further comprising:
a user accessible internet-based portal for managing the compilation account, the user accessible internet-based portal being configured to permit the consumer to input account data about the plurality of existing credit card accounts belonging to the consumer and to permit the consumer to set the preferences that determine which of the plurality of existing 1 credit card accounts to use for a particular type of transaction.

7. A computer-implemented method of using one of a plurality of existing credit accounts belonging to a consumer, the method comprising:
providing account data to a compilation account service provider about the plurality of existing credit accounts belonging to the consumer;
providing the consumer with a compilation account associated with the plurality of existing credit accounts of the consumer;
storing preferences of the consumer that determine selection of one of the plurality of existing credit accounts belonging to the consumer;
the consumer performing a primary credit transaction using the compilation account; and
performing a secondary credit transaction related to the primary transaction between the compilation account and one of the plurality of existing credit accounts based on the stored preferences of the consumer.

8. The computer-implemented method according to claim 7, wherein the stored preferences include selecting a default existing credit account among the plurality of existing credit accounts to use for a particular transaction type.

9. The computer-implemented method according to claim 8, wherein the stored preferences include selectively overriding the default existing credit account and using another existing credit account when the other existing credit account offers a promotion.

10. The computer-implemented method according to claim 9, wherein the promotion includes, for the particular transaction type, one of additional loyalty/rewards points/miles/currencies/credits, a discount on the transaction, a prize, a gift, cash-back and a donation.

11. The computer-implemented method according to claim 7, wherein the stored preferences further include selection of a charitable organization to which to make a donation from the compilation account that includes one of a percentage of a common rewards-currency, an amount of the common rewards-currency, a cash equivalent amount of the common rewards-currency and revenue sharing on merchant commissions.

12. The computer-implemented method according to claim 7, further comprising:
providing a user accessible internet-based portal for managing the compilation account;
inputting the account data, by the consumer, through the internet-based portal, to the compilation account service provider about the plurality of existing credit accounts belonging to the consumer; and
setting the preferences, by the consumer, through the internet-based portal, that determine which of the plurality of existing credit accounts to use for a particular type of transaction.

13. A computer-implemented method of managing a plurality of existing credit accounts belonging to a consumer, the method comprising:
providing the consumer with a compilation account associated with the plurality of existing credit accounts of the consumer;
providing a user accessible internet-based portal for managing the compilation account;
inputting account data, by the consumer, through the internet-based portal, to a compilation account service provider about the plurality of existing credit accounts belonging to the consumer;
setting preferences, by the consumer, through the internet-based portal, that determine which of the plurality of existing credit accounts to use for a particular type of transaction;
the consumer performing one of a credit transaction and a debit/PIN transaction using the compilation account; and
treating, at the compilation account service provider, the respective one of the credit transaction and the debit/PIN transaction as a credit transaction directed to a particular one of the plurality of existing credit accounts based on the preferences at least partially set by the consumer.

14. The computer-implemented method according to claim 13, wherein the internet-based portal includes links to promotional offers, the links permitting the consumer to at least temporarily override the stored preferences in order to take advantage of one or more of the promotional offers.

15. The computer-implemented method according to claim 13, wherein the type of transaction includes one of a personal transaction and a business transaction.

16. The computer-implemented method according to claim 13, further comprising
tracking gift card account numbers, promotional discount codes, rain checks and/or refunds, thereby providing a single place to manage all payment types including stored value cards, gift cards, internet promotional offerings; and
applying the gift card account numbers, promotional discount codes, rain checks and/or refunds to appropriate consumer transactions.

17. The computer-implemented method according to claim 13, wherein the type of transaction includes at least one of a retail purchase, a gas station purchase, a supermarket purchase, a travel ticket purchase, a hotel/motel payment and a services payment.
